(19) United States
(12) Patent Application Publication
(10) Pub. No.: US 2012/0195472 A1
(43) Pub. Date: Aug. 2, 2012

(54) MOTION ADAPTIVE DE-INTERLACING APPARATUS AND METHOD

(75) Inventor: Yu-Mao LIN, Tainan City (TW)

(73) Assignee: NOVATEK MICROELECTRONICS CORP., Hsinchu (TW)

(21) Appl. No.: 13/362,926

(22) Filed: Jan. 31, 2012

(30) Foreign Application Priority Data
Jan. 31, 2011 (TW) 100103718

(51) Int. Cl. G06K 9/00

(52) U.S. Cl. 382/107

(57) ABSTRACT

A motion adaptive de-interlacing apparatus includes a motion detection unit, an adaptation unit and a motion recursion unit. The motion detection unit is for calculating multiple current motions of multiple pixels of an image block. The adaptation unit analyzes at least one image characteristic of the image block to accordingly adjust and determine an adaptive factor. The motion recursion unit blends the current motions and multiple previous motions corresponding to the pixels according to the adjusted adaptive factor to obtain multiple blending motions.

This application claims the benefit of Taiwan application Serial No. 100103718, filed Jan. 31, 2011, the subject matter of which is incorporated herein by reference.

### BACKGROUND

1. Technical Field

The invention relates in general to a motion adaptive de-interlacing apparatus and method, and more particularly to a motion adaptive de-interlacing apparatus and method capable of improving quality of whole images.

2. Background

A traditional motion adaptive de-interlacing apparatus detects motions of objects and controls the blending of pixels alternative in space and time according to a constant blending ratio α to obtain multiple blending motions. However, for a pixel block having objects moving fast and repeatedly, the motion detection may fail because a constant frame refresh rate, such as 60 Hz or 120 Hz, is insufficient for displaying the fast speed objects. That is, the moving objects may be regarded as still objects due to the insufficient frame refresh rate, and then pseudo still problems are caused. Moreover, some combing problems are also caused around the moving objects.

The constant blending ratioα of the traditional motion adaptive de-interlacing apparatus will be set higher to avoid generating the pseudo still problems in the high fast frames, but it causes moving objects in a small portion of the still frames or noise interference regions to generate motion hysteresis problems, thus lowering display quality of the frames.

### SUMMARY

The disclosure is directed to a motion adaptive de-interlacing apparatus and method, analyzing image characteristics and accordingly adjusting an adaptive factor, thus capable of improving quality of whole images.

According to a first aspect of the present disclosure, a motion adaptive de-interlacing apparatus is provided. The motion adaptive de-interlacing apparatus includes a motion detection unit, an adaptation unit and a motion recursion unit. The motion detection unit is for calculating multiple current motions of multiple pixels of an image block. The adaptation unit analyzes at least one image characteristic of the image block to accordingly adjust and determine an adaptive factor. The motion recursion unit blends the current motions and multiple previous motions corresponding to the pixels according to the adjusted adaptive factor to obtain multiple blending motions.

According to a second aspect of the present disclosure, a motion adaptive de-interlacing method is provided. The motion adaptive de-interlacing method includes the following steps. Multiple current motions of multiple pixels are calculated in an image block. At least one image characteristic of the image block is analyzed to accordingly adjust and determine an adaptive factor. The current motions and multiple previous motions corresponding to the pixels are blended according to the adjusted adaptive factor to obtain multiple blending motions.

The invention will become apparent from the following detailed description of the preferred but non-limiting embodiments. The following description is made with reference to the accompanying drawings.

### BRIEF DESCRIPTION OF THE DRAWINGS

FIG. 1 shows a motion adaptive de-interlacing apparatus according to an embodiment of the invention.

FIG. 2 shows a block diagram of one example of an adaptation unit according to an embodiment of the invention.

FIG. 3 shows a flow chart of an example of adjustment and determination of the adaptive factor according to an embodiment of the invention.

FIG. 4 shows a flow chart of another example of adjustment and determination of the adaptive factor according to an embodiment of the invention.

### DETAILED DESCRIPTION OF THE INVENTION

The disclosure proposes a motion adaptive de-interlacing apparatus and method, analyzing image characteristics and accordingly adjusting an adaptive factor, thus capable of performing a motion adaptive de-interlacing operation on images according to the adjusted adaptive factor and improving quality of whole images.

In the present disclosure, a motion adaptive de-interlacing apparatus is provided. The motion adaptive de-interlacing apparatus includes a motion detection unit, an adaptation unit and a motion recursion unit. The motion detection unit is for calculating multiple current motions of multiple pixels of an image block. The adaptation unit analyzes at least one image characteristic of the image block to accordingly adjust and determine an adaptive factor. The motion recursion unit blends the current motions and multiple previous motions corresponding to the pixels according to the adjusted adaptive factor to obtain multiple blending motions.

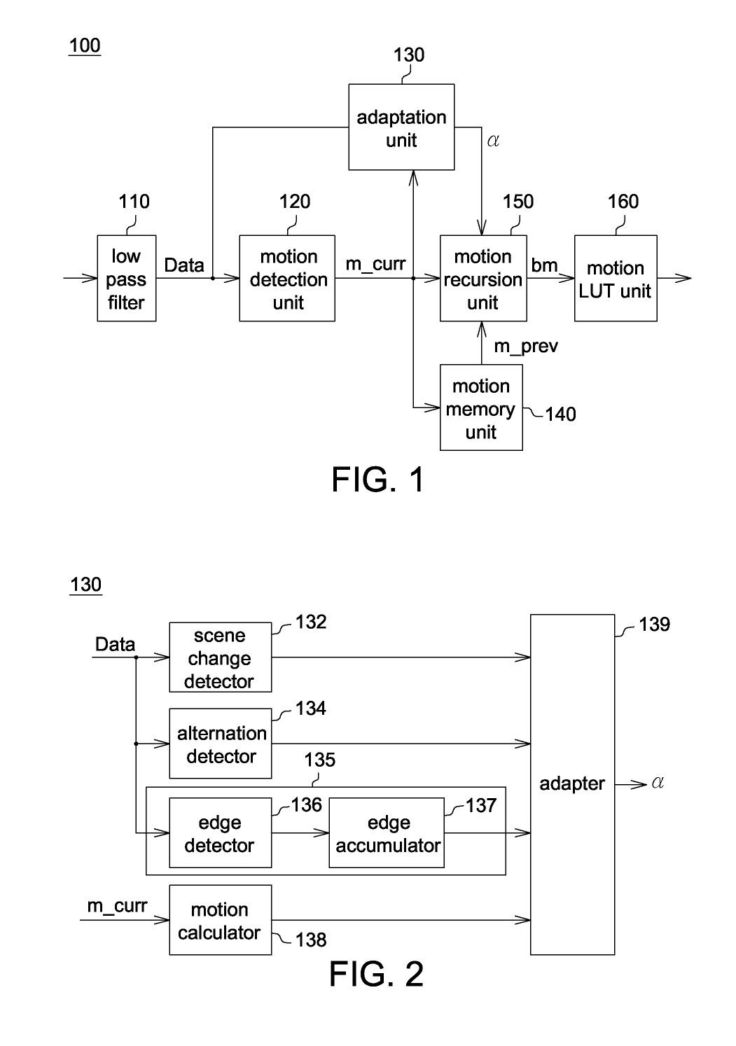

Referring to FIG. 1, a motion adaptive de-interlacing apparatus according to an embodiment of the invention is shown. The motion adaptive de-interlacing apparatus 100 includes a low pass filter 110, a motion detection unit 120, an adaptation unit 130, a motion memory unit 140, a motion recursion unit 150 and a motion LUT unit 160. The low pass filter 110 is used for low pass filtering inputted data pixel to remove possible noise, and the low pass filtered data pixel Data is transmitted to the motion detection unit 120 and the adaptation unit 130.

The motion detection unit 120 calculates multiple current motions m_curr of multiple pixels of an image block. The image block is an image frame or an image filed for example, and is determined according to requirements. The motion may be obtained by difference values of the pixel between two neighboring frames or fields. Meanwhile, the adaptation unit 130 analyzes at least one image characteristic of the image block according to the pixel data Data transmitted from the low pass filter 110 or the current motion m_curr calculated by the motion detection unit 120, and adjusts and determines an adaptive factor according to the analyzed results. The image characteristic is such as a scene change, a whole average motion, a edge characteristic or a black frame/white frame alternation, and is not limited thereto.

The motion memory unit 140 is used for storing multiple previous motions m_prev of multiple pixels corresponding to the image block. The motion recursion unit 150 respectively blends the current motions m_curr and the corresponding previous motions m_prev to obtain multiple blending motions bm according to the adaptive factor α adjusted by the adaptation unit 130. The blending of the current motions m_curr and the previous motions m_prev is performed according to the following equation (1).

bm=m_{—}curr×(1−α)+m_{—}prev×α (1)

Afterwards, the motion LUT unit 160 outputs the blending motions bm to be multiple adjusted blending motions according to a motion LUT.

Take the image characteristics include the scene change, the whole average motion, the edge characteristic and the black frame/white frame alternation as being exemplified below, and is not limited thereto. Referring to FIG. 2, a block diagram of one example of an adaptation unit according to an embodiment of the invention is shown. The adaptation unit 130 includes a scene change detection unit 132, an alternation detector 134, an edge calculator 135, a motion calculator 138 and an adapter 139. The scene change detector 132 receives the pixel data Data and detects differences between current pixel data and previous pixel data of the pixels to determine a scene change index. That is, the scene change detector 132 determines the magnitude of the scene change index according to whether the scene is changed. For example, when the scene is change, such as a dark scene is switched to a bright scene, the scene change detector 132 sets the scene change index to be a low index value. On the other hand, the scene change detector 132 sets the scene change index to be a high index value. Assume that the base is 16, then the low index value ranges between 1 to 5, the high index value ranges between 12 to 15, and a middle index value ranges between 6 to 11.

The alternation detector 134 receives the pixel data Data to determine an alternation index according to the pixel data Data. The alternation detector 134 substantially detects whether the frame is in the sequence of the black frame/the white frame/the black frame/the white frame . . . according to the inputted pixel data Data. If the frame is in the sequence, the alternation detector 134 sets the alternation index to be a low index value; otherwise, the alternation detector 134 sets the alternation index to be a high index value.

The edge calculator 135 includes an edge detector 136 and an edge accumulator 137. The edge detector 136 receives the pixel data Data and detects multiple edge orientations according to the current pixel data of the pixels. The edge orientations are horizontal, vertical, diagonal or messy for example. The edge accumulator 137 respectively accumulates numbers of the different edge orientations to determine an edge index. For example, when the edge accumulator 137 determines the edge number with the messy orientation is larger, the edge accumulator 137 sets the edge index to be a low index value. If the edge accumulator 137 determines that all kinds of the edge orientations are all few (a smooth trend), the edge accumulator 137 sets the edge index to be a high index value.

The motion calculator 138 receives multiple current motions m_curr of the same image frame or the same image field, and accumulates the current motions or calculates an average motion of the current motions to compare with a corresponding predetermined threshold value to determine a motion index. If the predetermined threshold value is smaller, the motion calculator 138 sets the motion index to be a high index value; if the predetermined threshold value is larger, the motion calculator 138 sets the motion index to be a low index value.

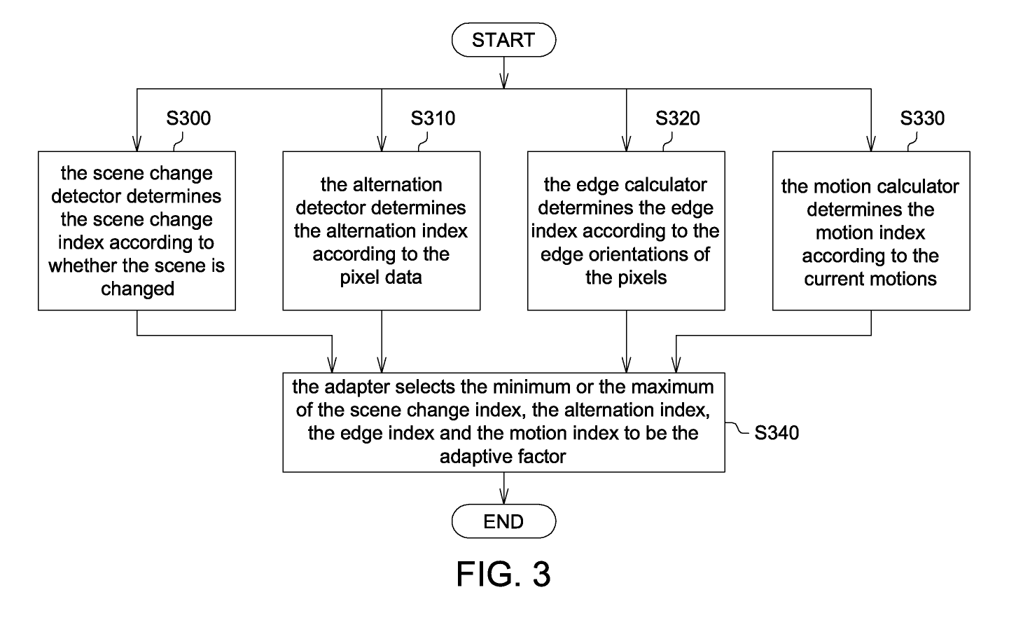

The adapter 139 adjusts and determines the adaptive factor α according to the scene change index, the alternation index, the edge index and the motion index, and outputs the adaptive factorα to the motion recursion unit 150. Referring to FIG. 3, a flow chart of an example of adjustment and determination of the adaptive factor according to an embodiment of the invention is shown. In step S300, the scene change detector 132 determines the scene change index according to whether the scene is changed. In step S310, the alternation detector 132 determines the alternation index according to the pixel data. In step S320, the edge calculator 135 determines the edge index according to the edge orientations of the pixels. In step S330, the motion calculator 138 determines the motion index according to the current motions. Afterwards, in step S340, the adapter 139 selects the minimum or the maximum of the scene change index, the alternation index, the edge index and the motion index to be the adaptive factor α.

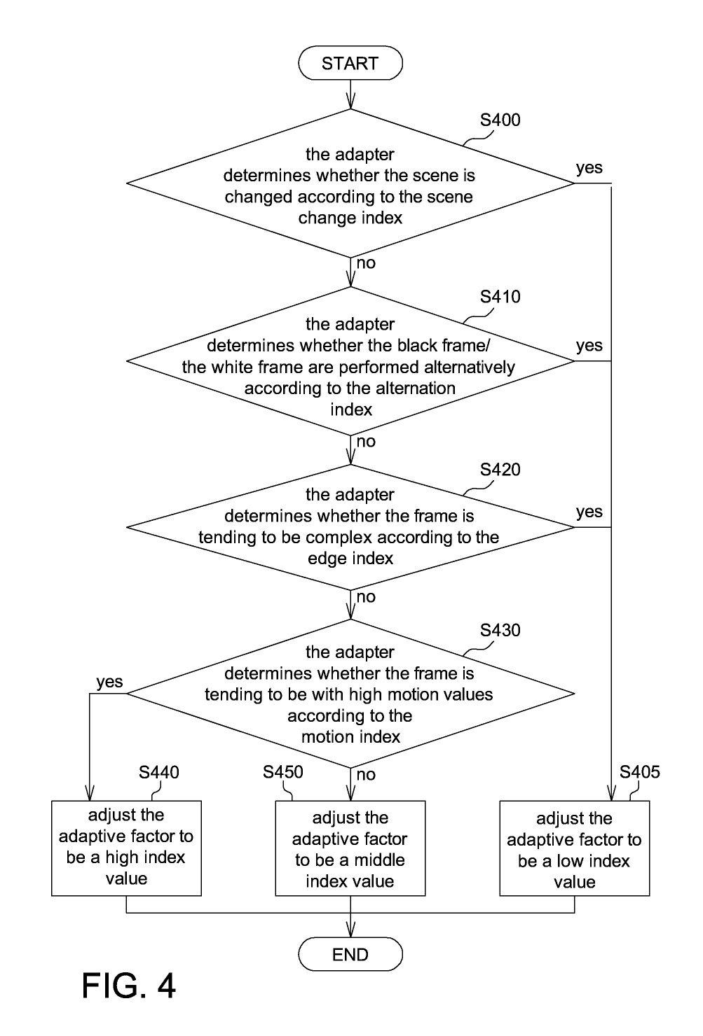

In addition, the adapter 139 may adjust and determine the adaptive factor α according to a sequence of the scene change index, the alternation index, the edge index and the motion index. Referring to FIG. 4, a flow chart of another example of adjustment and determination of the adaptive factor according to an embodiment of the invention is shown. In step S400, the adapter 139 determines whether the scene is changed according to the scene change index. If the scene is changed, the adapter 139 adjusts the adaptive factor α to be a low index value in step S405. If the scene is not changed, in step S410, the adapter 139 determines whether the black frame/the white frame are performed alternatively according to the alternation index. If the black frame/the white frame are performed alternatively, it proceeds to step S405. If the black frame/the white frame are not performed alternatively, in step S420, the adapter 139 determines whether the frame is tending to be complex according to the edge index. If the frame is tending to be complex, it proceeds to step S405. If the frame does not tend to be complex, in step S430, the adapter 139 determines whether the frame is tending to be with high motion values according to the motion index. If the frame is tending to be with high motion values, the adapter 139 adjusts the adaptive factor α to be a high index value in step S440. If the frame does not tend to be with high motion values, the adapter 139 adjusts the adaptive factor α to be a middle index value in step S450.

The above adaptation unit 130 can analyze at least one image characteristic of the image block according to the pixel data Data or the current motions m_curr, and adaptively adjust the magnitude of the adaptive factor α according to the analyzed results. Therefore, the motion adaptive de-interlacing apparatus 100 proposed in the disclosure improves not only pseudo still problems caused in an frame with numerous high speed objects, but also motion hysteresis problems caused in an frame with numerous still objects. Thus the quality of whole images is improved.

In addition, the disclosure also proposes a motion adaptive de-interlacing method. The motion adaptive de-interlacing method includes the following steps. Multiple current motions of multiple pixels are calculated in an image block. At least one image characteristic of the image block is analyzed to accordingly adjust and determine an adaptive factor. The current motions and multiple previous motions corresponding to the pixels are blended according to the adjusted adaptive factor to obtain multiple blending motions. Multiple adjusted blending motions are outputted according to the blending motions and a motion LUT.

The detailed principles of the above motion adaptive de-interlacing method have been described in the motion adaptive de-interlacing apparatus 100 and related descriptions, so detailed description thereof will be omitted.

The motion adaptive de-interlacing apparatus and method proposed in the disclosure analyzes image characteristics by pixel data and current motions, and adjust an adaptive factor according to the analyzed results, thus improving pseudo still problems caused in an frame with numerous high speed objects and motion hysteresis problems caused in an frame with numerous still objects. Hence the quality of whole images is improved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A motion adaptive de-interlacing apparatus, comprising:
a motion detection unit for calculating a plurality of current motions of a plurality of pixels in an image block;
an adaptation unit for analyzing at least one image characteristic of the image block to accordingly adjust and determine an adaptive factor; and
a motion recursion unit for blending the current motions and a plurality of previous motions corresponding to the pixels according to the adjusted adaptive factor to obtain a plurality of blending motions.

2. The motion adaptive de-interlacing apparatus according to claim 1, wherein the image block is an image frame or an image field.

3. The motion adaptive de-interlacing apparatus according to claim 1, wherein the adaptation unit comprises:
a scene change detector unit for detecting differences between current pixel data and previous pixel data of the pixels to determine a scene change index;
an alternation detector for determining an alternation index according to the pixels;
an edge calculator for detecting a plurality of edge orientations corresponding to the pixels according to the current pixel data of the pixels and respectively accumulating the edge orientations to determine an edge index;
a motion calculator for calculating the current motions to determine a motion index; and
an adapter for adjusting and determining the adaptive factor according to the scene change index, the alternation index, the edge index and the motion index, and outputting the adaptive factor to the motion recursion unit.

4. The motion adaptive de-interlacing apparatus according to claim 3, wherein the adaptive factor is adjusted to be the minimum or the maximum of the scene change index, the alternation index, the edge index and the motion index.

5. The motion adaptive de-interlacing apparatus according to claim 3, wherein the adapter adjusts and determines the adaptive factor according to a sequence of the scene change index, the alternation index, the edge index and the motion index.

6. The motion adaptive de-interlacing apparatus according to claim 1, further comprising:
a low pass filter for filtering the pixels to remove noise; and
a motion memory unit for storing the previous motions.

7. The motion adaptive de-interlacing apparatus according to claim 1, further comprising:
a motion LUT unit for outputting a plurality of adjusted blending motions according to the blending motions and a motion LUT.

8. A motion adaptive de-interlacing method, comprising:
calculating a plurality of current motions of a plurality of pixels in an image block;
analyzing at least one image characteristic of the image block to accordingly adjust and determine an adaptive factor; and
blending the current motions and a plurality of previous motions corresponding to the pixels according to the adjusted adaptive factor to obtain a plurality of blending motions.

9. The motion adaptive de-interlacing method according to claim 8, wherein the image block is an image frame or an image field.

10. The motion adaptive de-interlacing method according to claim 8, further comprising:
detecting differences between current pixel data and previous pixel data of the pixels to determine a scene change index;
determine an alternation index according to the pixels;
detecting a plurality of edge orientations corresponding to the pixels according to the current pixel data of the pixels and respectively accumulating the edge orientations to determine an edge index;
calculating the current motions to determine a motion index; and
adjusting and determining the adaptive factor according to the scene change index, the alternation index, the edge index and the motion index, and outputting the adaptive factor to the motion recursion unit.

11. The motion adaptive de-interlacing method according to claim 10, further comprising:
adjusting the adaptive factor to be the minimum or the maximum of the scene change index, the alternation index, the edge index and the motion index.

12. The motion adaptive de-interlacing method according to claim 10, further comprising:
adjusting and determining the adaptive factor according to a sequence of the scene change index, the alternation index, the edge index and the motion index.

13. The motion adaptive de-interlacing method according to claim 8, further comprising:
outputting a plurality of adjusted blending motions according to the blending motions and a motion LUT.
